(19) United States
(12) Patent Application Publication
(10) Pub. No.: US 2009/0159694 A1
(43) Pub. Date: Jun. 25, 2009

(54) Card and System for Transmitting Electric Energy

(76) Inventors: Riku Rikkola, Tampere (FI); Antti Backman, Tampere (FI)

Correspondence Address: SEYFARTH SHAW LLP, 131 S. DEARBORN ST., SUITE 2400, CHICAGO, IL, 60603-5803, US

(21) Appl. No.: 12/083,171

(22) PCT Filed: Oct. 5, 2006
(86) PCT No.: PCT/FI2006/050427

§ 371 Date: Apr. 7, 2008

(30) Foreign Application Priority Data
Oct. 7, 2005 (FI) 20055542

(51) Int. Cl. G06K 19/077

(52) U.S. Cl. 235/492

(57) ABSTRACT

The invention relates to a card, the card (10) comprising identifiers (3), with which the primary use of the card (10) can be implemented. The card is characterized in that it further comprises a solar panel (2) positioned on the card (10) and consisting of solar cells, interface means (21, 22) for transmitting energy collected by the solar panel (2) to devices external to the card in such a way that the card's (10) solar panel (2) allows the card to have an additional use separate from said primary use, the additional use being arranged to forward current supply provided by the solar panel (2) to external devices (40) separate from the card. Further, the invention relates to a card receiver (30) and a system for transmitting electric energy for electronic devices.

### BACKGROUND OF THE INVENTION

The invention relates to transmitting electric energy generated as a result of a photoelectric effect to an electronic device, and particularly to a card and a card receiver, and to a system in which identification cards or corresponding cards can be utilized as part of a system transmitting electric energy.

Generation of electric energy based on a photoelectric effect has been seen as a potential source of supply energy, particularly for small-sized portable electronic devices. Generation of electric energy based on a photoelectric effect is carried out with solar panels. It is known that a solar panel consists of one or more solar cells. Further, it is generally known that also other light sources apart from the sun may be used for activating the photoelectric cells of a solar panel.

Cards of a charge card type that include a solar electric system are known. The electric energy generated is, however, used to serve internal functional characteristics of these cards. Further, the production costs of such system cards are high.

Publication US2003019942 discloses an improved device of the size of a credit card for collecting and storing solar energy. In the publication energy is stored in a battery comprised by the card, and then exploited on the card. The problem with the system described above is that the physical dimensions of the card restrict the size of the electricity storage to be positioned in connection with it, and therefore also the available capacity for storing electric energy. Positioning the electric storage on a card further increases the costs of the card manufacture. The above cards are only suitable for their primary object(s) of use, which may be one or several. In some cards, primary use is supported by a solar system. Exploiting such cards is, however, confined to their primary use. Cards and their solar systems thus become useless when the primary use has ended. Cards become useless when, for example, the validity of the card expires.

### BRIEF DESCRIPTION OF THE INVENTION

An object of the invention is thus to provide a system and a card implementing the system and a card receiver in such a way that above problems can be solved. The object of the invention is achieved with a system, card and card receiver that are characterized in what is stated in the independent claims. The dependent claims are directed to the preferred embodiments of the invention.

The invention relates to a device for transmitting electric energy generated as a result of a photoelectric effect to a portable electronic system, and particularly to utilizing what are called credit-card-sized identification cards as part of such a system. Further, the invention relates to a card and a card receiver for charging electronic devices.

One object of the invention is to provide a card for the purpose of charging portable electronic devices. The purpose of the card according to the invention is to enable charging of electric devices by means of solar energy, and particularly to charging electric devices by means of solar energy collectors of the size of cards, for example of the size of credit cards.

A second object of the invention is to provide a card receiver for the purpose of charging portable electronic devices. The card receiver according to the object of the invention is able to receive a card having a solar panel as well as interface means attached to it.

A third object of the invention is a system for the purpose of charging portable electronic devices.

One embodiment of the invention provides a card comprising identification means by means of the primary use of the card can be implemented. The card comprising identification means may be, for instance, a credit or charge card with a chip, a charge card with an EMV (Europay, MasterCard, Visa) and/or PKI (Public Key Infrastructure) certificate, magnetic track card, Dual Interface (contact identification and contactless identification) card, company card, identification card, membership card, key card, bonus card, phone credit card, or a card containing a SIM (subscriber identity module), USIM (universal subscriber identity module), UICC (universal integrated circuit card), ISIM (IP multimedia services identity module), R-UIM (removable user-identity module), W-SIM (Willcom-SIM) etc.

What these credit-card-sized cards provided with a solar panel and supplying electric energy to devices external to the card have in common is that they have at least one primary purpose of use. Identification means are related to this primary purpose of use of the card. Identification means may have active and/or passive identification characteristics as well as functional characteristics related to storing and processing of data. This is the case for instance with smart and memory cards. Active identification characteristics refer, in this context, to characteristics that are readable by an external arrangement intended for identifying a card and/or its user. An external arrangement can be used by means of an automatic electric system and/or by activation by a user. Examples of such identifiers include a magnetic track, bar code, RFID, bio-ID, smart chip and memory chip. Passive identifiers, in turn, include for instance a hologram, signature, embossing, photograph, company logo, trade mark and identifier that is visible on the card surface or can be made visible from it.

An embodiment of one object of the invention provides a card that may be of what is called credit-card-sized. It is obvious that the size of the card may vary. At the moment, a credit card or a corresponding card is a rectangular card rounded at the edges and of the size of about 86 mm * 54 mm * 1 mm. One credit-card-related standard is ISO CR-80, for example. Further, it can be noted that many cards of the size of a credit card have boundary dimensions deviating from the above but they are still visually comparable to this size.

The card comprises one or more solar cells that convert(s) the solar radiation into electric energy. The generation of electric energy in the card is based on a photoelectric effect, and for achieving it, solar cells of high efficiency are used which form a solar panel when connected in series and/or in parallel.

The card being flat-shaped, it is natural that the solar panel is positioned on those card surfaces that have the largest area. In known cards of the credit card type, these surfaces are conventionally provided with a magnetic track and a smart chip, for example. It is possible, however, to provide all surfaces of a rectangular card rounded on edges with solar panels. The area of a solar panel formed on one surface by the solar cells of the card is, at most, equal to the size of this card surface. The solar panel may also be located on inner layers of the card, provided that the material layers between the light source and the solar panel in each particular case permeate radiation, which is required for activating a photoelectric effect on the card.

In the implementation, a solar panel is to be positioned and dimensioned in such a way that the card can still be used for its primary object of use. In a magnetic track card, for example, a solar panel may be positioned above and below the magnetic track, because the magnetic track covers only a small portion of the whole area of the card's back surface. Several present-day cards have an empty, unused portion. The card according to the invention allows the area of the card to be used more efficiently.

A solar panel of the above type, consisting of solar cells, is positioned on the card. The card has interface means for transmitting energy collected by the solar panel to devices external to the card in such a way that the card's solar panel allows the card to have an additional use separate from its above-mentioned primary use. Such an additional use is arranged to forward supply of electric energy provided by the solar panel to external devices separate from the card.

According to one embodiment, a card functioning as a support structure for the solar panel comprises as an interface means a contact surface through which the electric energy is transmitted to a card receiver, from where it can be conveyed further to a portable electronic target device.

As a result of the photoelectric effect, the electric energy generated in the solar cells can be, according to one embodiment of the invention, conveyed to the card receiver via identification elements integrated into the surface structure of the card. To transmit electric energy from the card, for instance a smart and memory chip, a hologram identifier, signature surface, embossing, company logo, trade mark (e.g. logo) and bar code may be used as interfaces. Thus, a conductive material layer or material in the identifier is utilized.

An embodiment of one object of the invention provides a card receiver for transmitting electric energy for electronic devices. The card receiver comprises receiving means for receiving at least one card with a solar panel consisting of solar cells. The receiving means receive electric energy supply provided for interface means by the card, and the supply means provide electric energy supply for an external device connected to the card receiver. The card receiver may be, for instance, a holder, casing and/or display base. There may be a neckband, cable reel and/or clothes fastener connected to receivers according to the above description. It must be possible to provide said solutions with an interface mechanism compatible with an external device. It is further obvious that the piece connecting the card and the external device detachably may contain the same identifier or set of identifiers and the same contact manners as the card.

According to a second embodiment, the card receiver further comprises storing means for storing electric energy in the card receiver.

According to a third embodiment, the card receiver is arranged to receive two or more cards.

The card receiver, such as an adapter, may comprise means for managing the supply of electric energy. The adapter must naturally be connectable to a target device by its one end. However, on the side of the card, the interface may always be of the same kind, whereby any credit card of a standard size or the like card may also be used. The characteristics of the card according to the invention may preferably be added to existing cards, which allows them to have not only the primary use but also an additional use by means of which portable electronic devices can be charged, if required. The cards being of the same size, the user may, if desirable, use any card according to the invention.

An embodiment of one object of the invention provides a system for transmitting electric energy for electronic devices. The system comprises a card receiver detachably attachable to an electronic device, which receiver has, positioned in it, one or more cards with a solar panel consisting of solar cells in such a way that when the card is positioned in the card receiver, the energy collected by the solar panel of the card is transmitted via terminals on the card to the card receiver, from where the electric energy can be further transmitted to external devices to be connected to the receiver.

According to another embodiment, the card receiver stores electric energy with storing means if the electronic device has been detached from the card receiver. The system is able to exploit the card, which further comprises, in addition to the identification characteristics of the above type or the like, a solar panel.

The cards in use expire. The invention enables utilization of cards even after they cannot be used for their primary object of use. According to one embodiment, the card according to the invention provides an additional use for cards from which a SIM module is detached and transferred to a mobile phone. The remaining card base can be utilized for the additional use according to the invention. The invention thus enables further utilization of different cards, even after their primary use has ended or the validity expired. They can be further used for the charging purpose according to the invention.

The present invention allows mobile solar electric systems to be used in several different situations and objects of use. The user-friendliness increases, contributed by the small size of the card receiver. In accordance with the inventive idea, it is possible to manufacture portable charging devices based on a photoelectric effect, which devices can be used for charging mobile phones, handheld computers, portable computers and portable mass memory players, for example.

### BRIEF DESCRIPTION OF THE DRAWINGS

The invention will now be described in greater detail in connection with preferred embodiments, referring to the attached drawings, of which:

FIG. 1A shows an embodiment of the card according to the invention;

FIG. 1B shows the card of FIG. 1A with two different interface means;

FIG. 1C shows the card according to FIG. 1A with two different interface means;

FIG. 2A shows a second embodiment of the card according to the present invention;

FIG. 2B shows a third embodiment of the card according to the present invention;

FIG. 3 shows a fourth embodiment of the card according to the present invention;

FIG. 4A shows a fifth embodiment of the card according to the present invention;

FIG. 4B shows a sixth embodiment of the card according to the present invention;

FIG. 4C shows a seventh embodiment of the card according to present invention;

FIG. 4D shows an eighth embodiment of the card according to the present invention;

FIG. 4E shows a ninth embodiment of the card according to the present invention;

FIG. 4F shows a tenth embodiment of the card according to the present invention;

FIG. 5A shows an eleventh embodiment of the card according to the present invention;

FIG. 5B shows the card according to FIG. 5A, in which the interface means are located on sides of the SIM module;

FIG. 6 shows an embodiment of the card receiver according to the present invention;

FIG. 7 shows a second embodiment of the card receiver according to the present invention;

FIG. 8A shows a third embodiment of the card receiver according to the present invention;

FIG. 8B shows a fourth embodiment of the card receiver according to the present invention;

FIG. 9 shows a principled view of an embodiment of the system configuration;

FIG. 10 shows an embodiment of the connection between the card receiver and an electric device.

### DETAILED DESCRIPTION OF THE INVENTION

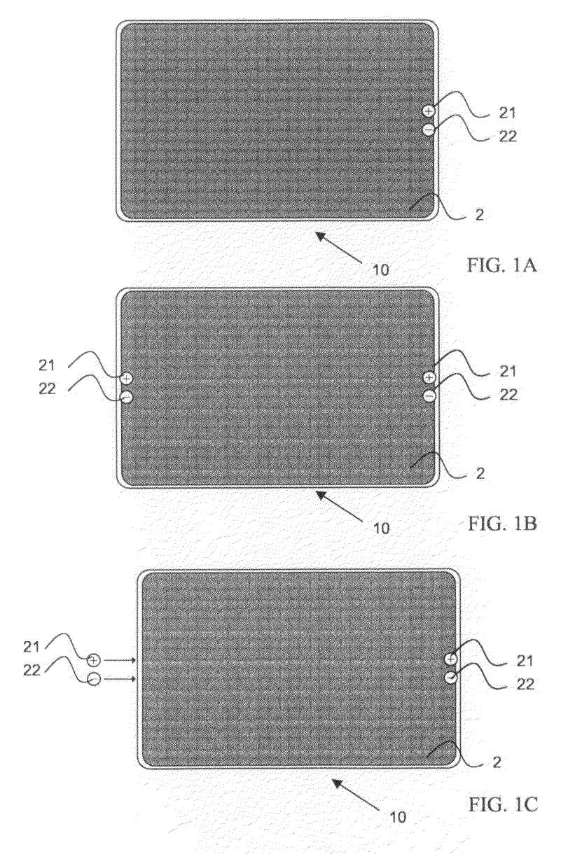

Referring to FIGS. 1A to 5B, which show embodiments of cards 10 according to the present invention. The card 10 is preferably of the size of generally known cards. The card 10 may be a credit card, charge card, identification card, smart card, SIM card or another corresponding card.

FIG. 1A shows an embodiment of the card according to the present invention, in which the support base of a contactless card is utilized with regard to data transmission. The card comprises interface means 21, 22, to which the card receiver, for example an intermediate cable or an intermediate piece of the type of a card casing, can be connected by means of receiver means of its own. With regard to data transmission, in a contactless card the interface means enabling transmission of electric energy can be positioned for instance in connection with an identifier (logo) denoting an organization and/or brand. The card's interface means can be positioned in any of the card's surface structures. The interface means 21, 22 comprise contact surfaces of a positive terminal 21 and a negative terminal 22. In addition, the card contains a solar panel 2 consisting of solar cells, which can, according to the above arrangement, be positioned to cover only a part, or the whole area of the card.

FIG. 1B shows a card in which interface means 21, 22 are also positioned at the opposite end of the card. In this case, the card 10 can be positioned in the card receiver in more than one way. The interface means according to FIG. 1A and 1B are positioned at the same point on opposite sides, but they may also be positioned at different points. This facilitates the use of the card 10. The number of interface means and their positions can be varied in a situation where cards are used in such a card receiver in which the receiving contact surfaces of the interface means are positioned at different points. Thus, different types of cards can be received with one card receiver if their interface means 21, 22 were positioned at different points.

FIG. 1C shows an embodiment of the card according to the present invention, where the interface means 21, 22 are positioned at both ends of the card. This arrangement allows the card 10 to be positioned in the receiver even in a more versatile manner than previously. The interface means of FIG. 1C comprise a positive terminal 21 and a negative terminal 22 that are positioned at the ends of the card, two on the upper surface and two on the end surface. It is obvious that one or more positive terminals 21 and negative terminals 22 can be positioned at the ends of the card and on sides at different points.

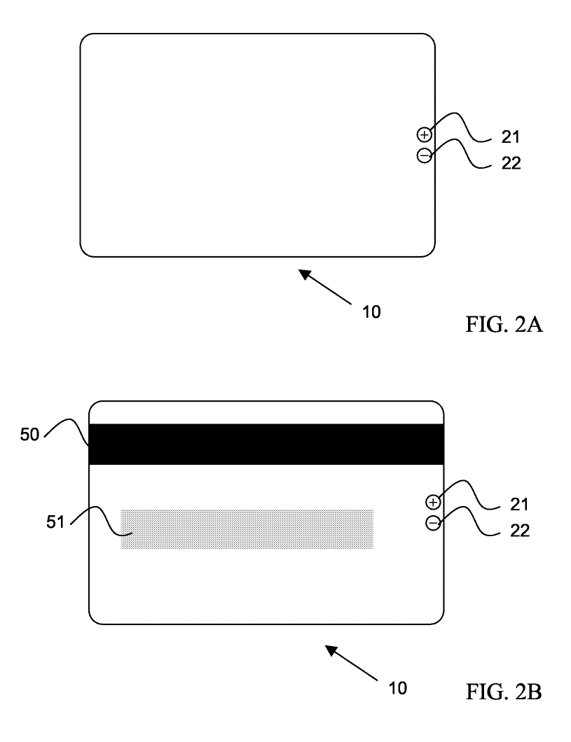

FIG. 2A shows a second embodiment of the card 10 according to the present invention. The positive terminal 21 and the negative terminal 22 of the interface means that convey electric energy outwards are positioned at the edge of one end in the figure, but they can as well be positioned on side edges of the card or within them. The interface means 21, 22 are here positioned on different sides of the card 10 than the solar panel. Thus, the interface means 21, 22 do not reduce the area of the solar panel.

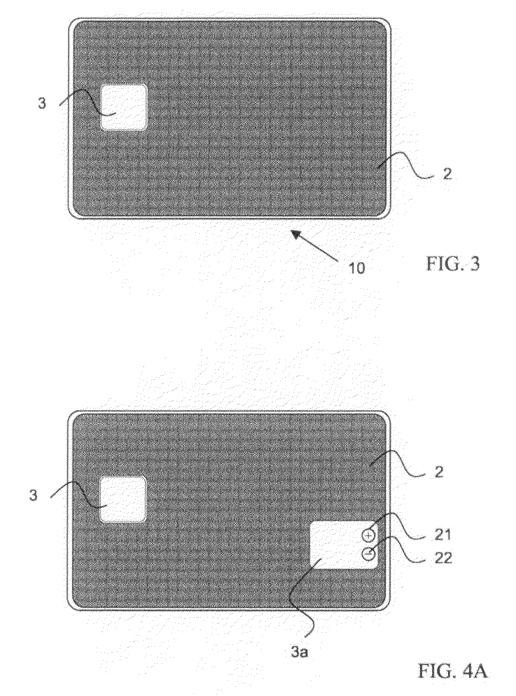

FIG. 2B shows a third embodiment of the card according to the invention. FIG. 6 shows a card 10, in which the support base for a magnetic track card is utilized. A magnetic track 50 and a signature area 51 function here as identification means. The solar panel is in this embodiment on the opposite side. Electric energy is conveyed from the card 10 from the backside of the magnetic track card. The magnetic track 50 and embossed letters are read by different devices, so they are read at separate times. Thus, the magnetic track 50 could as well be positioned on the same side as the embossed letters, whereby the whole area of the other side could be used for the panel. FIG. 3 shows a fourth embodiment of the card 10 according to the present invention, in which the support base of a smart card is utilized. The identification means 3 of the card comprise here a smart chip, the characteristics of which may vary according to the card's primary purpose of use. The solar panel 2 is in FIG. 3 positioned around the smart chip functioning as an identification means 3.

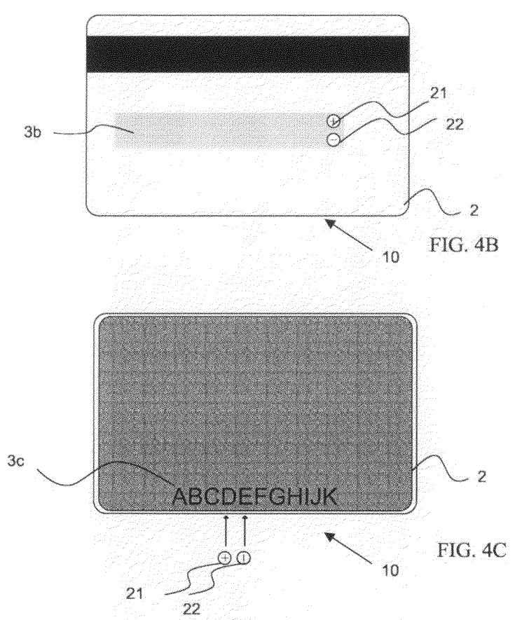

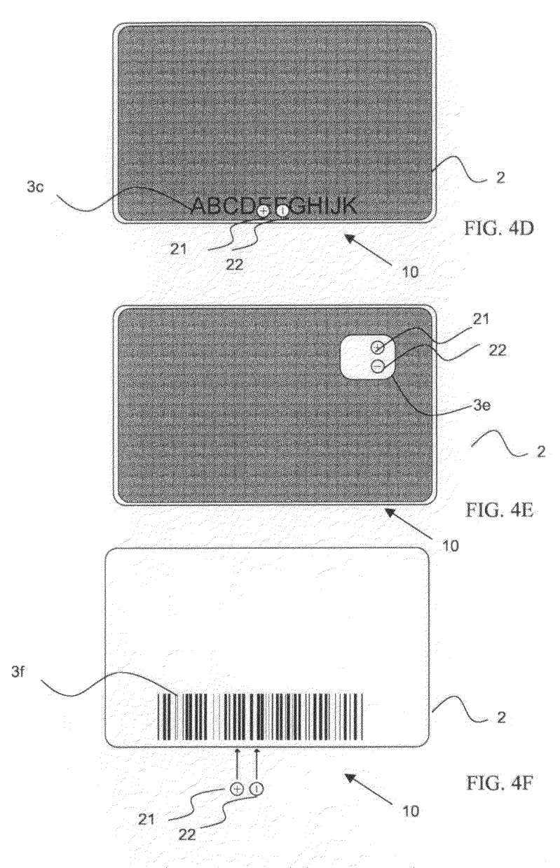

FIG. 4A shows a fifth embodiment of the card according to the invention. The card corresponds to the card according to FIG. 3, but its identification means 3 further comprise another identification means 3a that may be a holographic figure, for example. In this embodiment, the interface means 21, 22 of the card 10 are provided in connection with the primary identification means, i.e. holograms 3a. The primary identification means may also comprise a safety thread (not shown). The interface means can be positioned in connection with an identifier (e.g. logo) denoting an organization and/or brand, for instance. The intention is to exploit the conductive material layer or material in the identifier. FIG. 4B shows a sixth embodiment of the card according to the present invention. In this embodiment, the interface means 21, 22 of the card 10 are provided in connection with the primary identification means, i.e. a signature space 3b, of the card.

FIG. 4C shows a seventh embodiment of the card according to the present invention. In this embodiment, the interface means 21, 22 of the card 10 are provided in connection with the primary identification means, i.e. embossed letters 3c, of the card, on the opposite surface of the card.

FIG. 4D shows an eighth embodiment of the card according to the present invention. In this embodiment, the interface means 21, 22 of the card 10 are provided in connection with the primary identification means, i.e. embossed letters 3c, of the card.

FIG. 4E shows a ninth embodiment of the card according to the present invention. In this embodiment, the interface means 21, 22 of the card 10 are provided in connection with the primary identification means, i.e. a company logo 3e, of the card.

FIG. 4F shows a tenth embodiment of the card according to the present invention. In this embodiment, the interface means 21, 22 of the card 10 are provided in connection with the primary identification means, i.e. a bar code 3f, of the card, on the opposite side of the card.

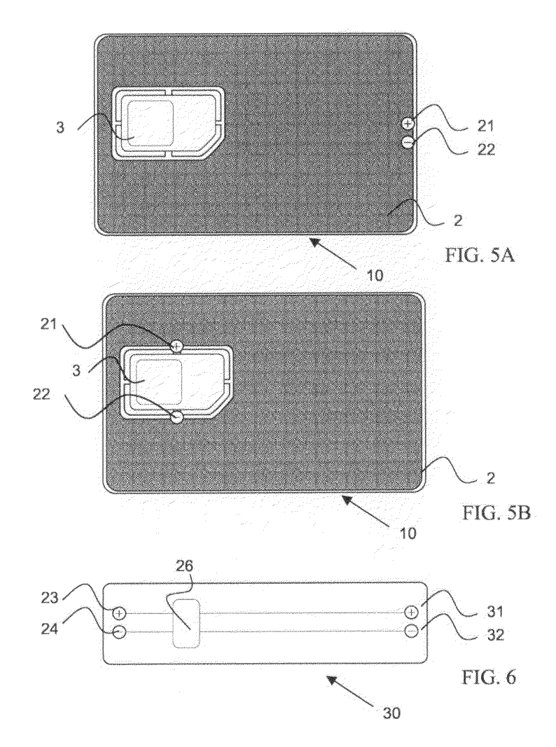

FIG. 5A shows an eleventh embodiment of the card 10 according to the present invention. FIG. 5A shows an embodiment of the card according to the present invention, in which the support base of a SIM module is utilized. Here, the identification means 3 is a SIM module, but it may as well be another corresponding module used in terminals, such as USIM (universal subscriber identity module), UICC (universal integrated circuit card), ISIM (IP multimedia services identity module), R-UIM (removable user-identity module) or W-SIM (Willcom-SIM). A SIM module is usually supplied in such a way that it has been manufactured on a card 10 of the size of a credit card. The identification means 3 is detached from the card 10 and transferred to the target device, such as a mobile communication device. In the embodiment, the support structures of the SIM cards are exploited even after the SIM module has been detached from the support structure.

FIG. 5B shows a card 10 in which the interface means 21, 22 are positioned adjacent to the SIM module 3 in such a way that the interface means 21, 22 stay on the card 10 even after the SIM module 3 has been detached. Thus, the interface means 21, 22 may be formed of conductive material in connection with forming the SIM module in connection with manufacturing the SIM module.

FIG. 6 shows an embodiment of a card receiver 30 according to the present invention. The card receiver 30 is an intermediate piece comprising receiving means 23, 24 of the input, which interface points are compatible with interface means 21, 22 of the card that transmit electric energy outwards. The card receiver 30 also comprises output interface points 31, 32 compatible with the input of the electronic target device that is intended for the supply of electric energy. The card receiver comprises a switch 26 for on/off switching of the reception.

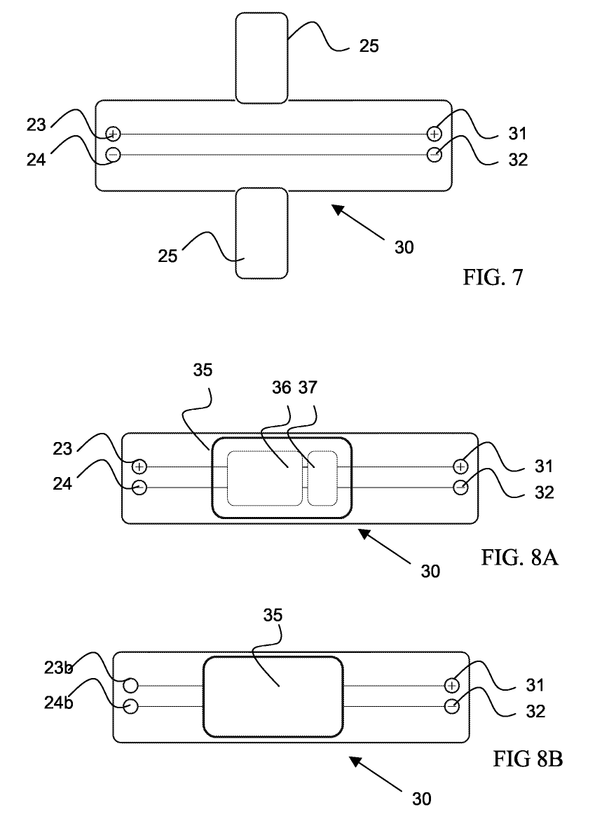

FIG. 7 shows a second embodiment of the card receiver 30 according to the present invention. The card receiver 30 is an intermediate piece comprising receiving means 23, 24 of the input, which interface points are compatible with the interface means 21, 22 of the card that transmit electric energy outwards. The card receiver 30 also comprises output interface points 31, 32 compatible with the input of the electronic target device that is intended for the supply of electric energy. The card receiver 30 comprises card receiving means 25, with which the card can be received to the card receiver 30. The receiving means 25 may comprise receiving means 25 of different sizes and attachment manners.

FIG. 8A shows a third embodiment of the card receiver 30 according to the invention. The card receiver comprises here a control unit 35 with electricity storage. The electricity storage may comprise for instance a battery 36 and/or a capacitor 37, and it may charge irrespective of whether the contact surface of the output of the intermediate piece is connected to the input of the electronic target device, intended for the supply of electric energy. The card receiver 30 may consist of one or more parts. The receiving part of the card may be a fixed part to which connection pieces compatible with target devices may be connected. In such a case, the card receiver can be utilized for connecting various target devices.

FIG. 8B shows a fourth embodiment of the card receiver 30 according to the present invention. The card receiver comprises here a control unit 35. The card receiver 10 provided with the control unit 35 may comprise receiving means 23b, 24b of the input, which are able to receive the card interface means 21, 22 on their contact surfaces irrespective of their polarity. The control unit 35 identifies the polarity of the card interface means 21, 22 to be received and switches them to be compatible with the target device. Thus, the card receiver 30 may also receive cards whose +/− terminals are oppositely on the card.

FIG. 9 shows a principled view of an embodiment of a system configuration. The card 10 is not activated until it is connected to an electric device 40 operated by means of the card receiver 30. In other words, the card 10 has no battery of its own but the card is passive and is activated when being connected into operation, either by physically joining the system parts together or by using a switch positioned in the card receiver. The card receiver 30, in turn, has electricity storage comprising a battery 36 and/or a capacitor and separate means 31, 32 for being connected to a desired device, for instance a mobile phone.

The intermediate piece 30 may be connected to the contact surface of the output of the card 10. The connection can be implemented mechanically, by means of negative pressure, chemically, magnetically or electrically.

The electric energy generated as a result of a photoelectric effect in the solar cells 2 can be conveyed to the intermediate piece via the interface means 21, 22 of the card.

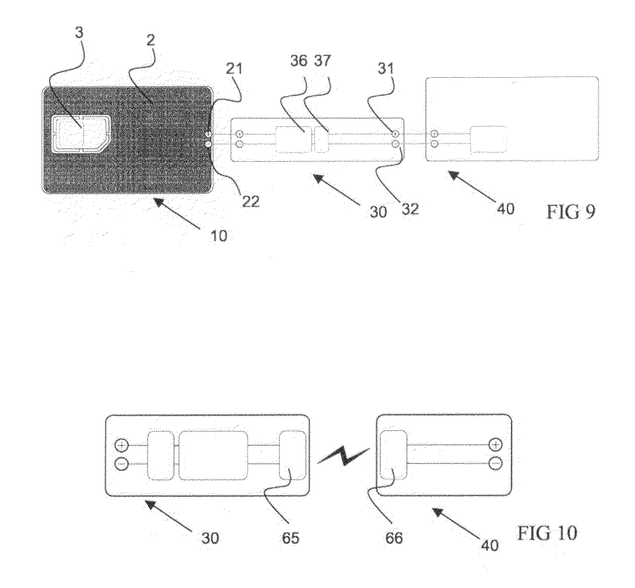

FIG. 10 shows an embodiment of a connection between the card receiver and an electric device, which is a wireless connection. Electric energy is transferred wirelessly by means of electromagnetic induction. The card receiver comprises a transmitter 65 for transmitting electric energy. The electric device, in turn, comprises a receiver 66 for receiving the electric energy transmitted by the transmitter 65.

Thus, the invention provides a preferred card, a card receiver and a system that enables utilization of charge cards, smart cards, memory cards or identification cards for the charging purpose of portable electronic devices. The invention utilizes existing cards, whereby their primary use is not hindered or endangered, but the card according to the invention allows the card, for instance a credit card, bonus card etc. to have an additional feature with which the card can be used not only for its primary purpose but also as a charging device or a source of electricity, depending on the energy consumption of the device.

It is obvious to a person skilled in the art that as the technology advances, the basic idea of the invention can be implemented in a plurality of ways. The invention and its embodiments are thus not restricted to the above-described examples but they may vary within the claims.

1. A card, the card comprising
identification means by means of which the primary use of the card can be implemented, the card being characterized in that it further comprises, p1 a solar panel positioned on the card,
interface means for transmitting energy collected by the solar panel to devices external to the card in such a way that the solar panel of the card allows the card to have an additional use separate from its primary use, the additional use being arranged to forward electric energy supply provided by the solar panel to external devices separate from the card.

2. A card according to claim 1, characterized in that the card is of the size of a credit card.

3. A card according to claim 1, characterized in that the area and position of the solar panel of the card are arranged in such a way that the identification means of the card are usable.

4. A card according to claim 1, characterized in that said interface means of the card are provided in connection with the primary identification means of the card.

5. A card receiver, for transmitting electric energy for electronic devices, characterized in that the card receiver comprises receiving means for receiving a card with a solar panel, receiving means to receive electric energy supply provided by the card for the interface means, and supply means to provide current supply for an external device connected to the card receiver.

6. A card receiver according to claim 5, characterized in that the card receiver further comprises storing means for storing electric energy in the card receiver.

7. A card receiver according to claim 5, characterized in that the card receiver further comprises an electric energy control unit for controlling the reception of electric energy.

8. A card receiver according to claim 6, characterized in that the card receiver is arranged to receive two or more cards.

9. A system for transmitting electric energy for electronic devices, characterized in that the system comprises a card receiver detachably attachable to an electronic device, one or more cards with a solar panel consisting of solar cells being installed in the receiver in such a way that when the card receiver has the card installed in it, the energy collected by a solar panel on the card is transmitted via interface means on the card to the card receiver, from which the electric energy is further transmittable to external devices to be connected to the receiver.

10. A system according to claim 9, characterized in that the card receiver stores electric energy with storing means if the electronic device has been detached from the card receiver.
